(19) United States
(12) Patent Application Publication
(10) Pub. No.: US 2021/0194303 A1
(43) Pub. Date: Jun. 24, 2021

(54) Rotor of a Permanent-Magnet Dynamoelectric Rotary Machine

(71) Applicant: Siemens Aktiengesellschaft, Muenchen (DE)

(72) Inventors: Bernd PFANNSCHMIDT, Rosstal (DE); Tobias STAERZ, Pegnitz (DE); Wolfgang WETZEL, Herzogenaurach (DE)

(21) Appl. No.: 16/078,456

(22) PCT Filed: Jan. 26, 2017
(86) PCT No.: PCT/EP2017/051664

§ 371 Date: Aug. 21, 2018

(30) Foreign Application Priority Data
Feb. 22, 2016 (EP) 16156724.3

(51) Int. Cl. H02K 1/32; H02K 1/27; H02K 9/06

(52) U.S. Cl. CPC H02K 1/32; H02K 9/06; H02K 1/278

(57) ABSTRACT

A rotor of a permanent-magnet dynamoelectric rotary machine includes a pot-type support unit that has at least one cylindrical wall, permanent magnets that are arranged on the outer periphery of the wall of the support unit, and substantially axially extending cooling ducts provided within the wall.

### CROSS-REFERENCE TO RELATED APPLICATIONS

This is a U.S. national stage of application No. PCT/EP2017/051664 filed Jan. 26, 2017. Priority is claimed on EP Application No. 16156724 filed Feb. 22, 2016, the content of which is incorporated herein by reference in its entirety.

### BACKGROUND OF THE INVENTION

### 1. Field of the Invention

The invention relates to a rotor of a permanently excited dynamoelectric rotary machine, and the dynamoelectric rotary machine.

### 2. Description of the Related Art

In permanently excited dynamoelectric machines, the magnet material of the permanent magnets has a maximum permitted upper limit of the service temperature, depending on the alloy composition. If this is exceeded, an irreversible demagnetization of the magnetic material occurs, which can destroy the rotor or otherwise at least critically impairs the operating behavior of the dynamoelectric machine. An impermissible heating of the permanent magnets of the rotor during operation of a dynamoelectric machine due to eddy current losses and the application of heat via the air gap from the stator can be prevented by air cooling the rotor in a targeted manner.

To date, such rotary dynamoelectric machines have been provided with radial or axial fans, which bring about an air exchange within the dynamoelectric machine, particularly via the air gap, and thus induce cooling of the permanent magnets. The cooling of the permanent magnets via the air gap of the dynamoelectric rotary machine is, however, inadequate in many cases.

### SUMMARY OF THE INVENTION

In view of the foregoing, it is an object of the present invention to provide a rotor of a dynamoelectric rotary machine, which allows efficient cooling of its permanent magnets, has a comparatively low moment of inertia and can be manufactured economically, in order to thus be able to provide a powerful electric drive for a wide variety of applications.

This and other objects and advantages are achieved in accordance with the invention by a rotor of a permanently excited dynamoelectric rotary machine with a pot-like support unit having at least one cylinder-shaped wall, where permanent magnets are arranged on the outer periphery of the wall of said support unit and cooling ducts extending essentially axially are provided in the wall.

It is also an object of the invention to provide a dynamoelectric machine with a rotor as claimed in one of the preceding claims, wherein an inlet guide vane arranged in a stationary manner is upstream of the rotor.

It is also an object of the invention to provide a machine tool, an electric car, a traction drive or an electrically driven aircraft, with at least one dynamoelectric machine.

The inventive cooling concept of the rotor is henceforth realized via a plurality of axially arranged cooling air ducts on a support unit. Due to the spatial proximity of the ducts, through which cooling air flows, to the permanent magnets, adequate cooling of the permanent magnets is ensured. Due to the comparatively large surface of the cooling ducts, in particularly, due to the number thereof or additional axially running ribs in the cooling ducts, the losses of the permanent magnets of the rotor are now transferred to the conveyed air and dissipated by convection via the support unit.

These losses in the permanent magnets arise due to eddy currents, among other reasons.

In this context, the cooling ducts are formed as closed or open when viewed in the peripheral direction. The open embodiment of the cooling ducts results in axially extending slots in the direction of the permanent magnets, where the slots provide a cooling air flow direct contact with at least part of a respective permanent magnet at these points.

It is particularly advantageous in this context if the support unit is formed and made of a material with good thermal conductivity, such as aluminum.

In order to reduce the weight and thus also the inertia of the rotor, this is provided with, in addition to a comparatively light material, a spoke-shaped support structure that is non-rotatably connected to the shaft. This support structure is therefore preferably only provided on one end of the supporting structure.

In order to dissipate the cooling air and to cool the winding head on at least one side of the stator, sections of the cooling ducts lead obliquely outward at an axial end region of the support unit, where the sections are located in an overhang of the support unit. This overhang is applied, when viewed axially, at one end of the wall of the support unit with a cylinder-shaped configuration. Furthermore, as a result of the bending cooling ducts in sections of the cooling ducts leading obliquely outward, a radial fan effect is induced, which inter alia thus can also be used to cool the winding heads at least on one side of the machine.

The inventive rotor thus consolidates the functions of torque transmission, cooling air transport and also heat dissipation from the permanent magnets arranged on it.

The rotor thus has a highly compact configuration both in the axial and radial direction and can be manufactured comparatively simply as a conventional turned or milled part from a non-magnetic material, yet one with comparatively good thermal conductivity, such as aluminum, in a cost-efficient manner. This is achieved in particular in that, in accordance with the invention, in such embodiments of the support unit and thus of the rotor, no undercuts occur during manufacturing and the processing levels lie in radially arranged levels.

In order to further reduce the weight and thus also the inertia of the rotor, the rotor is formed as a rotor bell open on one side or the support unit is formed with a pot-like shape.

In terms of flow, it is particularly advantageous if there is a preferred direction of rotation of the rotary machine and a stationary guide vane is then arranged in the intake region of the rotor, where the guide vane sets air spinning forward in a specified manner in the direction of the rotor during the primarily axial oncoming flow. Thus, the inlet losses in the cooling ducts of the support unit of the rotor are reduced as a result of flow separations.

The magnetic poles arranged on the support unit are either formed by classic magnets, i.e., north or south pole face the air gap, or by magnets in which the flux is guided in the rotor by the magnets themselves, such as in the case of laterally magnetized magnets or magnets in a Halbach array. Primarily in classic magnets, a flux-guiding layer should be additionally arranged between the support unit and magnet.

A combination of a conventional rotor or magnet carrier with axial cooling ducts and also a flow-optimized fan permanently connected to the shaft (radially/axially, drawing in/pushing out) as a separate component, e.g., manufactured by rapid prototyping technologies, represents an alternative solution of the inventive idea.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and further advantageous embodiments of the invention are to be inferred from the exemplary embodiments shown schematically, in which:

FIG. 1 shows a longitudinal section of a machine in accordance with the invention;

FIG. 2 shows a perspective representation of a support unit in accordance with the invention;

FIG. 3 shows a partial longitudinal section of a rotor in accordance with the invention;

FIG. 4 shows a partial longitudinal section of the rotor of FIG. 3 with an inlet guide vane;

FIG. 5 shows a detailed view of the surface of the rotor of FIG. 3;

FIGS. 6 and 7 show partial longitudinal sections of rotors with different overhangs in accordance with the invention; and

FIGS. 8 to 10 show partial cross-sections of rotors in accordance with the invention.

FIG. 1 shows a longitudinal section of a motor, which can be used as a drive, e.g., of a rail vehicle, an aircraft (e-aircraft) or a machine tool, where the drive has a dynamoelectric rotary machine 1 with a rotor 4 excited by a permanent magnet. Here, the dynamoelectric machine 1 has a stator 2, where there is provision for a winding system in axially running grooves (not shown in greater detail) of the laminated core of the stator 2, which winding system forms winding heads 3 on the end faces of the stator 2.

A rotor 4, which has permanent magnets 8 on a surface of a support unit 5 of the rotor 4, is at a distance from an air gap 15 of the stator 2 of the dynamoelectric machine 1. Located on the outer periphery of the support unit 5, which is formed in a pot-like manner, has a cylindrical shape at least in sections and faces toward the air gap 15, are accordingly the permanent magnets 8. The support unit 5 is connected to a shaft, which is mounted such that the support unit 5 can rotate about an axis 9, via a support structure 6.

The support structure 6 forms part of the support unit 5. If the support unit 5 is formed in one piece, then it contains at least the support structure 6, the cooling ducts 7 and the overhang 16.

There is provision for essentially axially extending ducts 7 radially below the permanent magnets 8, which ducts 7 each have a bend or overhang 16 with an outlet 12 at at least one end and thus, upon rotation of the rotor 4, generate a radial fan effect that additionally cools at least one winding head 3 of the stator 2 or at least provides an air mixing in this region.

In principle, there is provision in this context for at least one permanent magnet 8 per magnetic pole, when viewed in the axial and/or peripheral direction. Staggered or oblique arrangements of the magnetic poles are also provided, when viewed over the axial length of the rotor, if this is necessary for an operation of the dynamoelectric rotary machine without detent torques.

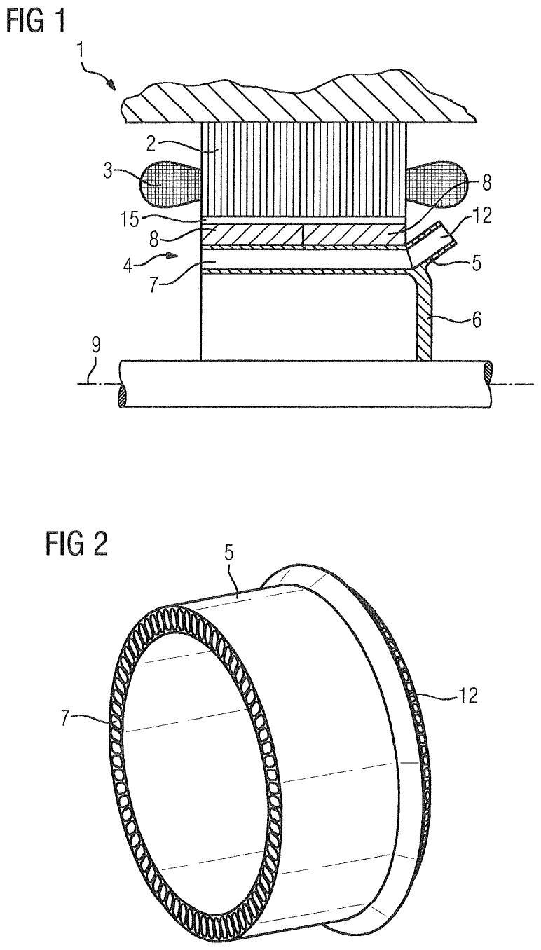

FIG. 2 shows, in a perspective view, a support unit 5 formed in one piece, in which the axially running cooling ducts 7 and the outlets 12 of the overhang 16 can be seen at an axial end of the support unit 5.

The support unit 5 thus has a highly compact configuration both in the axial and radial direction and can be manufactured comparatively simply as a conventional turned or milled part from a non-magnetic material, yet one with comparatively good thermal conductivity, such as aluminum, in a cost-efficient manner. This is achieved in particular because, in such an embodiment of the support unit 5 and thus of the rotor 4, no undercuts occur during manufacturing and the processing levels lie in radially arranged levels.

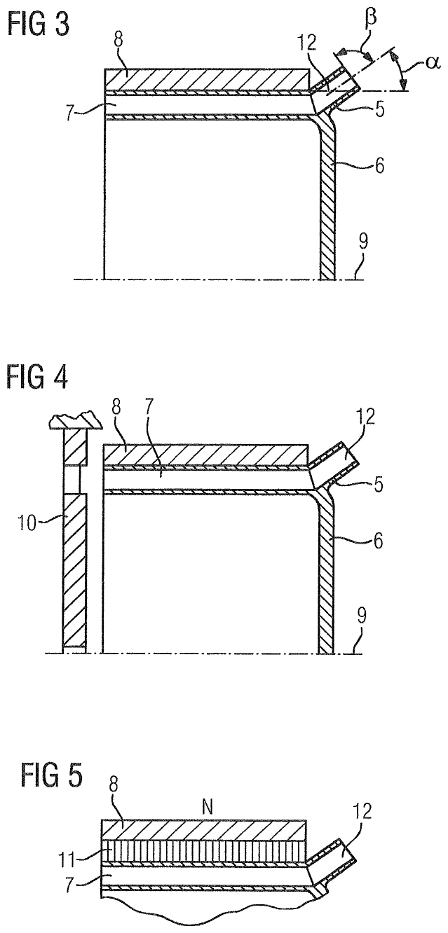

FIG. 3 shows, in a detailed representation, the rotor 4, which has the recesses 7 radially below its permanent magnets 8 which act as cooling ducts 7. On the other axial side of the rotor 4, these cooling ducts 7 are fitted with a bend guided outward in each case, which opens into an outlet 12.

The shaping of the overhang 16 is essentially specified by two angles α, β. Specifying the angles α, β influences the generation of noise, the blow-off direction of the outlet 12, the radial fan effect and suction effect of the support unit 5 and thus of the rotor 4.

In addition to the rotor 4 from FIG. 3, during operation of the dynamoelectric machine 1 with a preferred direction of rotation, the rotor 4 can have a stationary guide vane 10 in accordance with FIG. 4 axially upstream in the direction of flow, which is intended to reduce the flow losses of the cooling air entering the support unit 5. This is particularly advantageous in a preferred direction of the rotation of the dynamoelectric machine 1.

FIG. 5 shows, in a further embodiment, a permanent magnet 8 which is arranged on an intermediate layer, which is preferably formed as a laminate, in order to be able to better guide the magnetic flux. This involves a type of laminated core 11 which is positioned on the support unit 5, such as shrunk on. This embodiment is to be provided in the case of classic magnets in particular, in which, depending on the arrangement on the wall of the support unit 5, the north or south pole face the air gap 15.

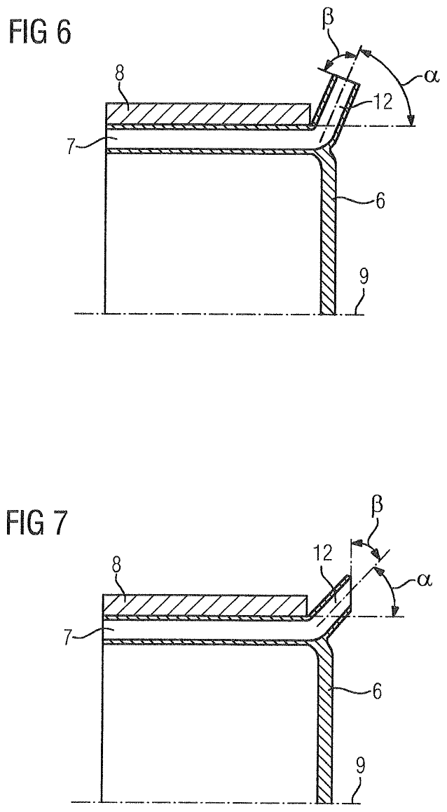

FIGS. 6 and 7 show different embodiments of the rotor 4 with regard to the embodiment of the overhang 16 or the outlet 12.

Here, the shaping of the overhang 16 is also essentially specified by two angles α, β. Specifying the angles α, β influences the generation of noise, the blow-off direction of the outlet 12, the radial fan effect and suction effect of the support unit 5 and thus of the rotor 4.

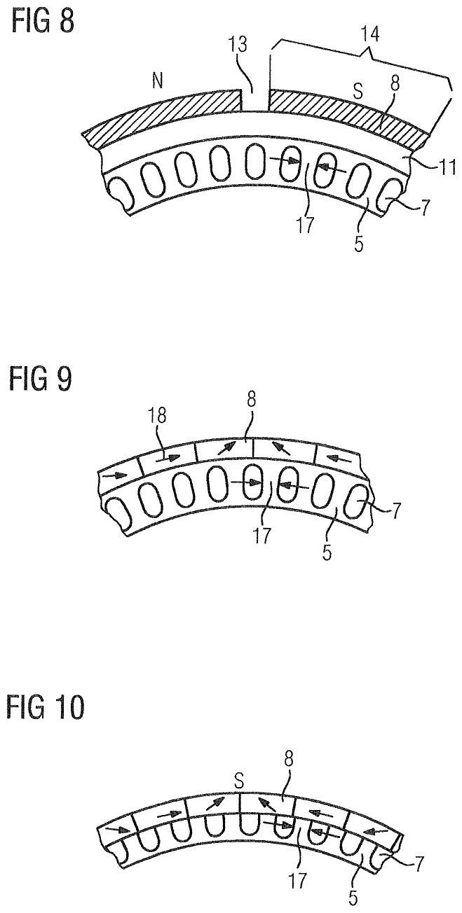

FIG. 8 shows, in a partial cross-section of the rotor 4, two magnetic poles 14 separated by a pole gap 13, where on one side a north pole (N) and at the adjacent pole a south pole (S) face the air gap 15. The polarity corresponding thereto in each case faces the wall of the support unit 5. In order to ensure a guiding of the magnetic flux in these permanent magnets 8, a magnetically conductive material is provided between the wall of the support unit 5 and the permanent magnets 8, if the support unit 5 is formed as a material lacking magnetic conductivity. This involves a type of laminated core 11 that is positioned on the support unit 5, such as shrunk on. The permanent magnets 8 are then affixed to the laminated core 11. There is provision in this context for at least one permanent magnet 8 per magnetic pole 14, when viewed in the axial and/or radial and/or peripheral direction.

FIG. 9 and FIG. 10 differ solely by the shaping of the cooling ducts 7. In FIG. 9, the cooling ducts 7 are closed when viewed in the peripheral direction. In FIG. 10, the cooling ducts 7 are at least partially radially open in the direction of the permanent magnet 8 or air gap 15.

FIG. 9 and FIG. 10 have partial magnets with different directions of magnetization 18 for each magnetic pole 14, when viewed in the peripheral direction. Thus, the course of the magnetic flux is “reproduced” for each pole 14.

In an ideal case, these permanent magnets 8 are magnetized laterally. A laminated core 11 for guiding flux according to the embodiments in accordance with FIG. 9 and FIG. 10 is thus no longer absolutely essential.

In principle, the permanent magnets 9 are arranged on the surface of the support unit 5, i.e., the wall facing the air gap 15. There, the permanent magnets 9 are affixed and secured by adhesive and/or bindings.

The cooling ducts 7 are formed with almost identical cross-sections in their axial course up to the outlet 12. In order to achieve an improved cooling effect, the cooling ducts 7 are equipped with an expanded cross-section in their axial course, which it should be understood can only be associated with a reduction of the web widths 17. Likewise, a change in cross-section over the axial course is conceivable, for example, from round to angular, as shown in FIG. 2, for example.

Furthermore, the number of cooling ducts 7 is assigned to a width of the pole 14 directly. In the case of a pole gap 13 in accordance with an embodiment shown in FIG. 8, the web width 17 can be enlarged there.

A dynamoelectric machine 1 of this kind with an inventive rotor 4 is used inter alia as a result of the low mass and thus also the inertia of the support unit 5 and the efficiency of the cooling of the permanent magnets 8 arranged thereon, primarily in production machines, such as machine tools for example, electric drives in vehicles, such as electric cars, traction drives of mining trucks or rail vehicles and electrically driven flying machines.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A rotor of a permanently excited dynamoelectric rotary machine comprising:
a pot-like support unit having at least one cylinder-shaped wall formed in one piece, the pot-like support unit including a support structure which is formed as one piece with the pot-like support unit; and
permanent magnets arranged on an outer periphery of the wall of said pot-like support unit formed as one piece, the support unit further including cooling ducts extending essentially axially in the wall which are formed as one piece with the pot-like support unit;
wherein the cooling ducts of the pot-like support unit are formed as closed or open radially outward when viewed in the peripheral direction;
wherein the cooling ducts on an axial end of the pot-like support unit open into an overhang formed as one piece with the cooling ducts, the pot-like support unit and the support structure; and
wherein the cooling ducts are formed such that a radial fan effect is generated upon rotation of the rotor.

8. The rotor as claimed in claim 7, wherein the pot-like support unit has a support structure, which is non-rotatably connectable to a shaft and which is spoke shaped.

9. The rotor as claimed in claim 7, wherein the support structure is located at an axial end of the pot-like support unit.

10. The rotor as claimed in claim 8, wherein the support structure is located at an axial end of the pot-like support unit.

11. The rotor as claimed in claim 7, wherein the permanent magnets are arranged in accordance with a Halbach array or the permanent magnets are formed as laterally magnetized permanent magnets.

12. A dynamoelectric machine with a rotor as claimed in claim 7, wherein an inlet guide vane arranged in a stationary manner is upstream of the rotor in terms of flow.

13. A machine tool, an electrically driven vehicle or an electrically driven aircraft, with at least one dynamoelectric machine as claimed in claim 12.
